(19) United States
(12) Patent Application Publication
(10) Pub. No.: US 2010/0035078 A1
(43) Pub. Date: Feb. 11, 2010

(54) EMBOSSED THERMAL SHIELD AND METHODS OF CONSTRUCTION AND INSTALLATION

(76) Inventors: Eric K. Staudt, Reading, PA (US); John E. Burdy, Morgantown, PA (US); Timothy D. Sellis, West Grove, PA (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/540,612

(22) Filed: Aug. 13, 2009

Related U.S. Application Data
(63) Continuation-in-part of application No. 11/972,363, filed on Jan. 10, 2008.
(60) Provisional application No. 60/884,551, filed on Jan. 11, 2007.

(51) Int. Cl. B32B 15/14; B32B 38/04

(52) U.S. Cl. 428/596; 156/253; 138/110; 138/127; 138/149

(57) ABSTRACT

A hand wrappable heat shield and method of construction thereof has outer and inner layers of metal embossed with peaks and valleys. An intermediate layer of insulation material is sandwiched between the outer and inner layers of metal. The peaks embossed in the outer layer are offset relative to the peaks embossed in the inner layer.

### CROSS-REFERENCE TO RELATED APPLICATIONS

This application is a continuation-in-part of U.S. patent application Ser. No. 11/972,363, filed Jan. 10, 2008, which claims the benefit of U.S. Provisional Application Ser. No. 60/884,551, filed Jan. 11, 2007, both of which are incorporated herein by reference in their entirety.

### BACKGROUND OF THE INVENTION

1. Technical Field

This invention relates generally to thermal/acoustic shields, and more particularly to wrappable multilayered, thermal/acoustic shields.

2. Related Art

Vehicles and other equipment that operate via an internal combustion engine contain various components that generate relatively high temperatures and vibration, ultimately radiating heat and producing noise. If left unchecked, the heat and noise from the components can have adverse affects on surrounding components and be otherwise unpleasant. For example, typical automotive vehicles have an exhaust system including exhaust pipes and catalytic converters which can reach 1200° Fahrenheit (° F.) or more. As such, it is generally desirable to place a thermal barrier, often referred to simply as a heat shield, adjacent the exhaust pipes and/or catalytic converter to prevent heat from radiating and impinging adjacent components and from entering a passenger compartment of the vehicle. In addition, heat shields are often used within an engine compartment of the vehicle to prevent radiant heat from having adverse affects on surrounding components, electrical lines, and hoses, for example, wherein elevated temperatures are becoming more commonplace due modern engine packages creating cramped environments.

Although heat shields are well known and generally considered necessary, they typically comprise one layer of heavy, rigid material, which are becoming less effective in blocking the increased temperatures and can be difficult to form, generally requiring expensive machinery, or two or more layers of material attached to one another through the use of adhesives and/or fasteners which tend to be relatively thick, inflexible and expensive. In addition, the heat shields are commonly exposed to a corrosive environment, which commonly results in there becoming damaged and/or loosened, thereby resulting in vibration and undesirable noise. Further, the heat shields are typically spaced from the source of heat, and thus, occupy valuable space that could otherwise be occupied by an adjacent component.

### SUMMARY OF THE INVENTION

A heat shield has outer and inner layers of hand wrappable metal material with embossed patterns of undulating peaks and valleys. An intermediate layer of insulation material is sandwiched between the outer and inner layers. The embossed patterns of undulating peaks and valleys of the outer and inner layers are offset from one another.

Another aspect of the invention includes a method of constructing a wrappable heat shield. The method includes providing first and second layers of metal material and a layer of insulation material. Then, sandwiching the layer of insulation material between the first and second layers. Further, embossing a pattern of peaks and valleys in the first and second layers of material with the peaks in the first layer being embossed in offset relation to the peaks in the second layer.

Accordingly, given the content of a heat shield constructed in accordance with the invention, the heat shield is lightweight, durable, effective in preventing heat from radiating outwardly therefrom, easy to install, and among other things, is economical in manufacture and in installation and exhibits a long and useful life.

### BRIEF DESCRIPTION OF THE DRAWINGS

These and other features and advantages of the present invention will become more readily appreciated when considered in connection with the following detailed description of presently preferred embodiments and best mode, appended claims and accompanying drawings, in which:

FIG. 1 is a an assembled partial perspective view of a heat shield constructed according to one presently preferred embodiment wrapped about an exhaust pipe;

FIG. 2 is a partial side view of the heat shield of FIG. 1;

FIG. 3 is a partial plan view of the heat shield of FIG. 1;

FIG. 4 is a schematic side view of an embossing apparatus for embossing a heat shield in accordance with the invention;

FIG. 5 is a partial side view of a heat shield constructed according to another embodiment of the invention;

FIG. 5A is an enlarged partial view of the heat shield of FIG. 5; and

FIG. 6 is an enlarged view of an embossing knob used in forming embossed pattern of FIG. 5A.

### DETAILED DESCRIPTION OF PRESENTLY PREFERRED EMBODIMENTS

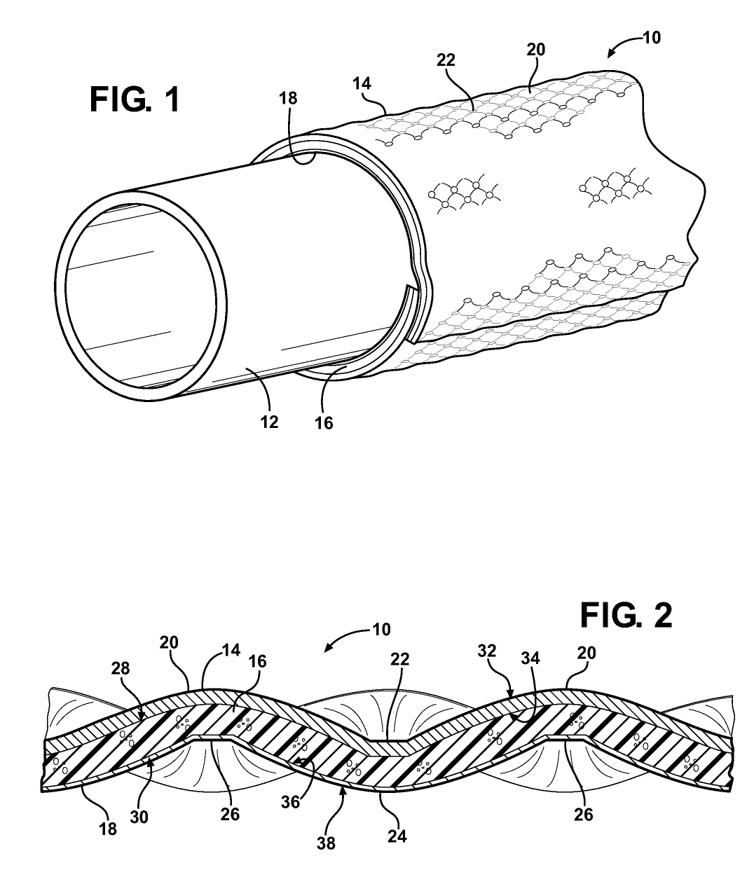

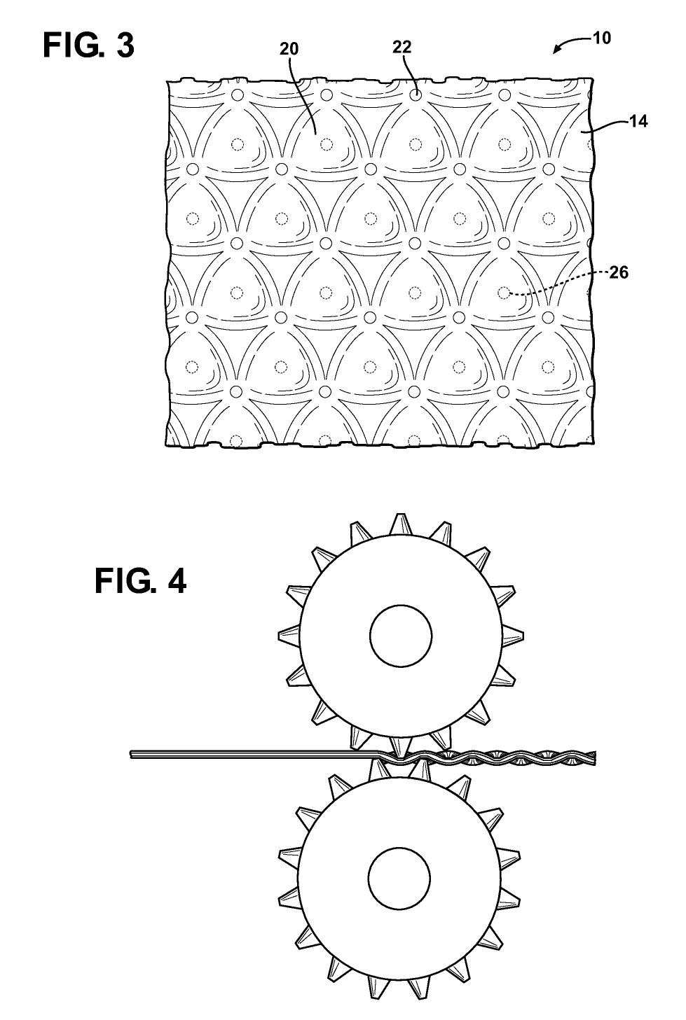

Referring in more detail to the drawings, FIGS. 1-3 show a thermal heat shield, referred to here after as heat shield 10, constructed according to one presently preferred embodiment of the invention. The heat shield 10 is shown in FIG. 1 as being formed, such as by being hand-wrapped, about an exhaust pipe 12 of a vehicle, such as an automotive vehicle, motorcycle, snowmobile, or other vehicle having an exhaust system (not shown), to prevent heat from radiating outwardly from the exhaust pipe, thereby preventing heat damage to nearby components. As best shown in FIGS. 1 and 2, the heat shield 10 has hand-wrappable layers, including a first or outer layer 14, an intermediate layer 16 and a second or inner layer 18. The outer layer 14 is formed of a metallic material providing a tough, durable outer layer that is resistant to damage, such as tearing from debris, stones and the like, such as can be kicked up from a road or ground surface. The intermediate layer 16 is sandwiched between the outer and inner layers 14, 18 and is formed of an insulation material to provide the heat shield 10 with an increased ability to prevent radiation of heat through the heat shield 10. The inner layer 18 is formed of a metallic material that is thinner than the outer layer 14, wherein the inner layer 18 protects the intermediate layer 16 prior to use and also provides further protection against heat from radiating radially outwardly from the heat shield 10. The outer layer 14 has a plurality of peaks 20 and valleys 22 embossed therein and the inner layer 18 has a plurality of peaks 24 and valleys 26 embossed therein, wherein the peaks 20 and valleys 22 of the outer layer 14 are offset relative to the peaks 24 and valleys 26 of the inner layer 18. The heat shield 10 is light weight and economical in construction, and it can be readily formed to attain any desired size and shape. Accordingly, the heat shield 10 can be used in a wide variety applications.

The intermediate layer 16 is fabricated from a non-woven insulation material, preferably capable of absorbing heat in the ranges of 1200° F. or more. Some exemplary materials, by way of example and without limitation, include polyester (PE), polyethylene terephthalate (PET), silica, basalt, glass fiber material or other ceramic fibrous materials. As best shown in FIG. 2, the intermediate layer 16 is provided having a thickness extending between opposite faces 28, 30, with the thickness being suitable for absorbing the heat anticipated in application, and is preferably provided having a thickness ranging between about 1/16 inch to 1 inch.

The outer layer 14 is formed from a relatively thin, light weight metal, such as aluminum or stainless steel, that can be hand formed or wrapped without the need of expensive forming machinery. The thickness of the outer layer 14 is preferably between about 0.006-0.020 inches. The outer layer 14 has opposite outer and inner faces 32, 34, wherein the inner face 32 is attached to one of the opposite faces of the intermediate layer 16, represented here as the face 28. The outer layer 14 is embossed with an embossing apparatus, such as illustrated in FIG. 4, to form the respective peaks 20 extending outwardly from the outer face 32 and valleys 22 extending inwardly toward the inner layer 18. The peaks and valleys 20, 22 are formed in adjacent rows such that the peaks 20 one row are offset or staggered from the peaks 20 in the adjacent row, and thus, the valleys 22 in one row are offset or staggered from the valleys 22 in the adjacent row.

The inner layer 18 is formed from a relatively thin, light weight metal, such as aluminum or stainless steel, that can be hand formed or wrapped in combination with the outer layer 14 without the need of forming machinery. The thickness of the inner layer 18 is preferably between about 0.001-0.002 inches. Accordingly, the inner layer 18 is thinner than the outer layer 14, and is generally provided as a “foil” layer. The inner layer 18 has opposite outer and inner faces 36, 38, wherein the outer face 36 is attached to one of the opposite faces of the intermediate layer 16, represented here as the face 30. The inner layer 18 is embossed with an embossing apparatus, such as illustrated in FIG. 4, to form the respective peaks 24 extending outwardly from the inner face 38 and valleys 26 extending inwardly toward the outer layer 14. The peaks and valleys 24, 26 are formed in adjacent rows such that the peaks 24 one row are offset or staggered from the peaks 24 in the adjacent row, and thus, the valleys 26 in one row are offset or staggered from the valleys 26 in the adjacent row.

In one embodiment, the outer layer 14 and inner layer 18 are laminated to the intermediate layer 16 to form a substantially flat lamination of the outer layer 14, the intermediate layer 16 and the inner layer 18. The lamination process can be performed by applying any suitable adhesive to the outer layer inner face 34, the inner layer outer face 36, and/or to the intermediate layer faces 28, 30. After laminating the layers to one another, the bonded layers are embossed such that the peaks 20 of the outer layer 14 and the peaks 24 of the inner layer 18 are configured in an offset relation from one another. In the embodiment illustrated, the peaks 20 of the outer layer 14 are aligned across the intermediate layer 16 opposite the valleys 26 of the inner layer 18. Thereafter, the desired size and shape of the heat shield can be cut, if necessary, from the laminated, embossed sheet assembly.

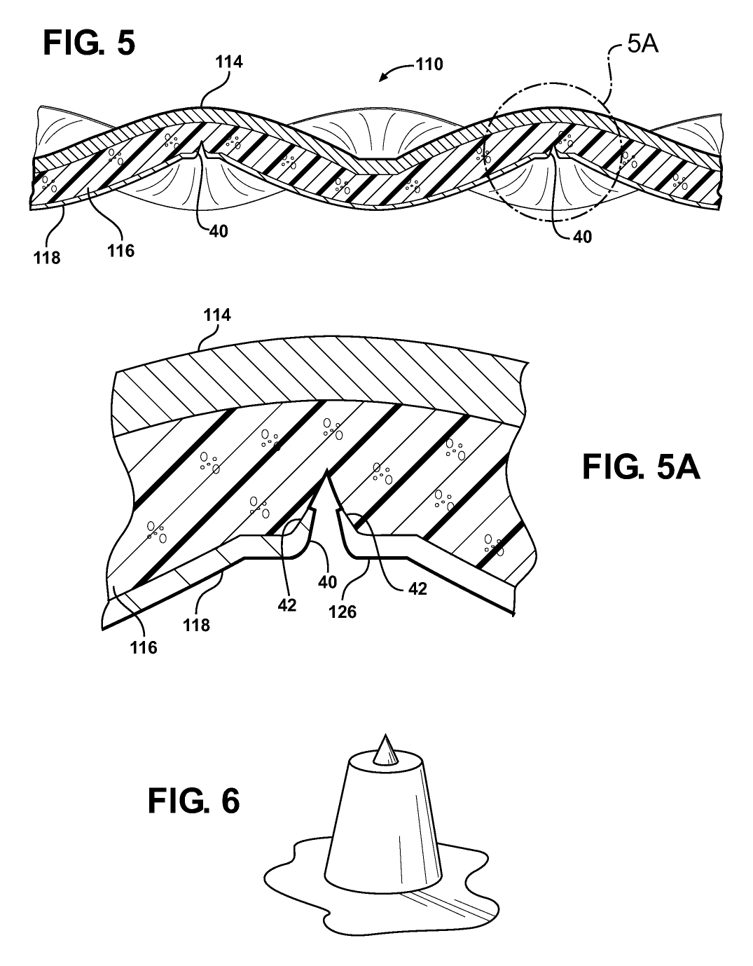

In FIG. 5, a heat shield 110 is illustrated in accordance with another aspect of the invention, with the same reference numerals being used as above, however, offset by a factor of 100, to indicate similar features. In manufacturing the heat shield 110, during the embossing process, a plurality of openings 40 are formed in the inner layer 118. The openings 40 are represented as extending through the valleys 126. Each of the openings 40 has protrusions, referred to hereafter as tangs 42, extending outwardly from the openings 40 into the intermediate layer 16. The tangs 42 can act to grip the material of the intermediate layer 16, while also providing a location through which heat and sound waves can flow into the trappings of the intermediate layer 16. As such, the openings 40 enhance the heat absorbing and sound attenuating capability of the heat shield 10.

In accordance with another aspect of the invention, a method of constructing a heat shield 10, 110 as described above is provided. The method comprises providing a first and second layers of metal material 14, 18, 114, 118 and a layer of insulation material 16, 116. Further, sandwiching and laminating the layer of insulation material 16, 116 between the first and second layers 14, 18, 114, 118 in bonded relation thereto, such as via a suitable adhesive layer. Then, embossing a pattern of peaks and valleys in the first and second layers of material with the peaks in the first layer 14, 114 being embossed in offset relation to the peaks in the second layer 18, 118. Then, if desired for the intended application, a step of forming a plurality of openings 40 in the inner layer 118 can be included. During the forming of the openings 40, a concurrent step of penetrating the insulation material 116 with tangs 42 of the inner layer metal material can be performed. Then, the heat shield 10, 110 can be sized by cutting a predetermined shape from the bonded, embossed layers. Finally, to assemble the heat shield 10, 110 in application, the method can further include hand wrapping the heat shield 10, 110 about the desired component.

Obviously, many modifications and variations of the present invention are possible in light of the above teachings. It is, therefore, to be understood that within the scope of the appended claims, the invention may be practiced otherwise than as specifically described.

What is claimed is:

1. A heat shield, comprising:
an outer layer of hand wrappable metal material having an embossed pattern of undulating peaks and valleys;
an intermediate layer of insulation material; and
an inner layer of hand wrappable metal material, said intermediate layer being sandwiched between said outer layer and said inner layer and said inner layer having an embossed pattern of undulating peaks and valleys, said peaks of said outer layer being offset from said peaks of said inner layer.

2. The heat shield of claim 1 wherein said peaks of said outer layer are aligned opposite said valleys of said inner layer.

3. The heat shield of claim 1 wherein said outer layer is between about 0.006-0.020″ thick and said inner layer is between about 0.001-0.002″ thick.

4. The heat shield of claim 1 wherein said inner layer has a plurality of openings.

5. The heat shield of claim 4 wherein said openings extend through said valleys of said inner layer.

6. The heat shield of claim 4 wherein tangs of said inner layer metal material extend from said openings into said intermediate layer.

7. The heat shield of claim 1 wherein said outer layer has adjacent rows of said peaks and valleys staggered relative to one another.

8. The heat shield of claim 7 wherein every other one of said rows has aligned peaks and valleys.

9. The heat shield of claim 1 wherein said intermediate layer is a non-woven material.

10. A method of constructing a heat shield, comprising:
providing a first layer of metal material;
providing a second layer of metal material;
providing a layer of insulation material;
sandwiching said layer of insulation material between the first and second layers; and
embossing a pattern of peaks and valleys in the first and second layers of material with the peaks in the first layer being embossed in offset relation to the peaks in the second layer.

11. The method of claim 10 further including laminating the first and second layers to the insulation material by bonding the insulation material to the first and second layers.

12. The method of claim 10 further including providing the first layer as an outer layer having a thickness between about 0.006-0.020″ and the second layer as an inner layer with a thickness between about 0.001-0.002″.

13. The method of claim 12 further including forming a plurality of openings in the inner layer.

14. The method of claim 13 further including penetrating the insulation material with tangs of the inner layer metal material.

15. The method of claim 13 further including forming the openings during the embossing step.

16. The method of claim 11 further including performing the laminating step prior to the embossing step.

17. The method of claim 16 further including cutting a predetermined shape from the bonded layers.

18. The method of claim 10 further including constructing the heat shield to be hand-wrappable.
